(19) United States
(12) Patent Application Publication
(10) Pub. No.: US 2007/0179325 A1
(43) Pub. Date: Aug. 2, 2007

(54) HYDROGEN STORAGE

(75) Inventors: Cornelis Johan Peters, Pijnacker (NL); E. Dendy Sloan, Golden, CO (US)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 11/539,491

(22) Filed: Oct. 6, 2006

Related U.S. Application Data
(63) Continuation-in-part of application No. PCT/NL05/00273, filed on Apr. 8, 2005.

(30) Foreign Application Priority Data
Apr. 8, 2004 (NL) NL 01025907

(51) Int. Cl. C07C 9/00

(52) U.S. Cl. 585/15

(57) ABSTRACT

Compositions and methods for storing hydrogen in a clathrate hydrate. The clathrate hydrate according to the present invention originates from a composition, which comprises water and hydrogen, as well as a promotor compound. The promotor compound provides a large reduction of the pressure needed and/or an increase of the temperature needed to form a clathrate hydrate. Also, the desorption of hydrogen gas from the clathrate hydrate is easily obtainable by decreasing the temperature to room temperature.

### CROSS-REFERENCE TO RELATED APPLICATIONS

This application is a continuation-in-part application of International Patent Cooperation Treaty (PCT) Application No. PCT/NL2005/000273, entitled “Hydrogen Storage”, to Technische Universiteit Delft, filed on Apr. 8, 2005, and the specification and claims thereof are incorporated herein by reference.

This application claims priority to and the benefit of the filing of Netherlands Patent Application Serial No. NL 1025907, entitled “Hydrogen Storage”, filed on Apr. 8, 2004, and the specification and claims thereof are incorporated herein by reference.

### BACKGROUND OF THE INVENTION

### Field of the Invention (Technical Field)

The present invention relates to the storage of hydrogen. The invention relates especially to a composition for obtaining a clathrate hydrate. The invention furthermore relates to a method for making a clathrate hydrate, as well as to the use of a promotor compound for facilitating the manufacture of the clathrate hydrate. Storing hydrogen is generally known in the art. The methods used at the moment are storing hydrogen under high pressure as a gas, storing hydrogen as a liquid, and adsorbing hydrogen (H2) in the form of a hydride in hydride-forming metals, metallic glass compounds or intermetallic compounds. All these methods have severe disadvantages.

Storing hydrogen as a gas requires heavy and large containers. Storing hydrogen as a liquid poses safety problems. Furthermore, lots of energy is required to convert hydrogen in the liquid phase and keeping it in said liquid phase. Metals, metallic glass compounds and intermetallic compounds offer the possibility of reversibly adsorbing a considerable amount of hydrogen at ambient temperature and ambient pressure, however, desorption takes place at elevated temperatures. A specific disadvantage of metal hydrides is their weight as well as the high operating pressure and temperature. Finally, it is known to form hydrogen hydrates, which has the disadvantage that high pressures are needed. The practical application is therefore almost impossible. It is also known to store hydrogen in the form of clathrate hydrates. This method also has the disadvantage that the pressure must be kept high and/or the temperature must be kept very low.

The invention now aims at providing an improved technique for storing hydrogen (H2), with which the disadvantages as mentioned above are minimized or completely removed.

The invention especially aims at providing a composition with which clathrate hydrates can be manufactured effectively.

The invention also aims at providing an improved method for manufacturing a clathrate hydrate. The invention provides a composition with which at least one of the aforementioned objectives is obtained.

### BRIEF SUMMARY OF THE INVENTION

When a promotor compound is incorporated into the composition, a clathrate hydrate is formed at a temperature and/or a pressure, which is much closer to ambient temperature and ambient pressure than when such a compound is not present. A decrease of the pressure needed to obtain a clathrate hydrate of at least 80% is possible without any further measures.

The cryogenic temperatures that are required without the presence of a promotor compound, are not required if a promotor compound is present. A clathrate hydrate will then be obtained even at ambient temperature or higher.

In this respect it is of importance to mention that to form a clathrate hydrate according to the state of the art, pure starting compounds were required. The presence of impurities was avoided at all times.

It is especially preferred that the promotor compound is an organic compound. Especially substituted organic compounds were shown to be suitable promotor compounds.

Especially, cyclic organic compounds were shown to be useful promotor compounds. Especially, if the cyclic organic compound comprises an atom other than carbon, pendant or incorporated in the ring, this compound is useful as a promotor compound. Furthermore, a cyclic organic compound having an oxygen atom, pendant or incorporated in the ring, is useful. Examples of promotor compounds that are especially useful are cyclobutanone, tetrahydrofurane, tetrahydropyrane or derivatives thereof, such as tetrahydrofuranol, tetrahydrofurfuryl alcohol and the like.

It was further shown that totally or partially halogenated organic compounds are useful promotor compounds. These organic compounds should preferably not contain more than ten carbon atoms, wherein these compounds preferably comprise no more than four carbon atoms. A very useful compound is trifluormethane. Other halogenides are useful as well, such as bromide, chloride and iodide compounds.

### DETAILED DESCRIPTION OF THE INVENTION

The manufacture of the clathrate hydrate with the composition according to the present invention is especially convenient if the composition has a temperature ranging from 150 to 373 degrees K and a pressure ranging from 0.1 to 150 Mpa. Under such circumstances, clathrate hydrate is manufactured expediently.

The method according to the invention for manufacturing a clathrate hydrate comprises the steps of:

1. providing a composition according to any of claims 1 to 8;

2. bringing the composition to a temperature ranging from 150 to 373 K and a pressure ranging from 0.10 to 150 MPa; and

3. transforming the composition during step 2. into a crystalline structure.

This is a very efficient method for obtaining a clathrate hydrate.

The storage of hydrogen in a clathrate hydrate according to the present invention has many advantages with respect to the state of the art. Compared with the state of the art the manufacture of the hydrate requires only little energy. Furthermore, the hydrogen can be removed from the hydrate at a slightly elevated temperature. According to another variation, the hydrogen may be desorbed from the clathrate hydrate by decreasing the pressure.

Compared with the storage systems according to the state of the art, the weight of the clathrate hydrate according to the invention is only very low. Also, the volume of the clathrate hydrate is compares very advantageously with respect to the known systems, especially the weight:volume ratio.

Examination of the clathrate hydrate according to the present invention has shown that the clathrate hydrate according to the present invention has a crystalline sII structure. If a double occupancy of the small cavities and a quadruple occupancy of the larger cavities in this structure are presumed, the molar concentration of hydrogen in the sII hydrate will be maximally 32%. This means a mass percentage of 5%.

However, the promotor compound that is added to the composition will occupy a portion of the possible sites available for hydrogen. Studies have shown that especially the large cavities are occupied by the promotor compounds. The maximum occupancy of the remaining sites yields a hydrogen storage in the clathrate hydrate which, if tetrahydrofuran is used as a promotor compound, is similar to the hydrogen storage in metal hydrides.

Tests were performed, wherein hydrogen having a purity of more than 99.99999%, and demineralized water were used. As a promotor compound, tetrahydrofuran having a purity of more than 99% was used (supplied by J. T. Baker). A ternary mixture having a molar composition of 92% H20, 3.2% H2 and 4.8% THF was used to measure the phase change:
Solid hydrate+liquid+vapour→liquid+vapour (HLV→LV).

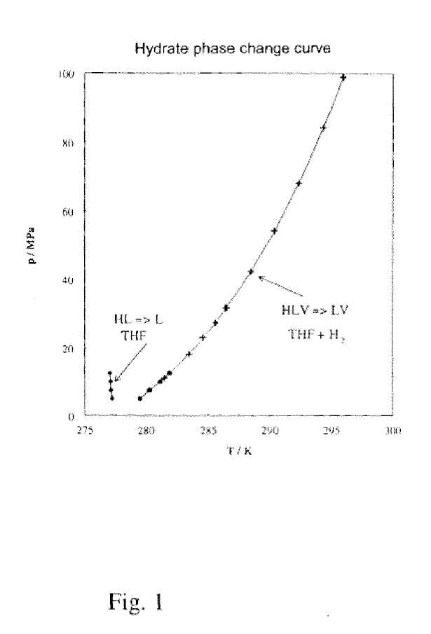

The results are shown in FIG. 1.

From FIG. 1 it is clear that at room temperature (279 K) and a pressure of about 50 bar a phase change occurs. At a pressure of about 1000 bar (100 Mpa) the phase change is positioned at a temperature of about 296 K.

In FIG. 1 also the phase change of the system: solid hydrate+liquid→liquid (HL→L) is shown. It can be clearly seen that the curve is completely different from the phase change of the system HLV→LV.

Therefore, FIG. 1 shows that the stability of the hydrogen hydrate in the presence of a promotor compound (in this case tetrahydrofuran, THF) is much improved with respect to the pure THF hydrate or a hydrogen hydrate.

X-ray diffraction has shown that the hydrogen/THF hydrate has the sII hydrate crystal structure. This is the same crystal structure that is found for pure H2 hydrate. The clathrate hydrate, comprising THF according to the present invention, was examined by means of a vibron spectrum. This showed that practically all, or at least a large fraction, of the large cavities in the sII matrix are occupied by THF, wherein only the small cavities can store hydrogen.

Furthermore, gravimetric measurements have shown that maximally two hydrogen molecules in each small cavity can be stored in the clathrate structure.

It has been shown that by means of the present invention and when tetrahydrofurane is used as promotor, the hydrogen clathrate hydrate formed can be stored at a pressure in the range of from 0.1 Mpa to 150 Mpa, preferably to 50 Mpa, and more preferably to 20 Mpa and more preferably still to 10 Mpa; and at a temperature in the range of from 150 to 350 degrees K, preferably to 350 degrees K, more preferably to 320 degrees K, and more preferably still to 300 degrees K. The hydrogen clathrate hydrate was shown in particular to be storable at a pressure of 10 Mpa or lower and a temperature of approximately 280 degrees K.

It was shown that with the present invention it is possible to store hydrogen in a water matrix in an amount that is about 230 times larger than is possible for gaseous hydrogen at ambient pressure, and that is about three times less than in liquid hydrogen. The amount of hydrogen that can be incorporated in the clathrate matrix as mentioned above is comparable to the mass fraction that can be incorporated in metal hydrides (about 1.8% by weight can be incorporated in the H2/THF hydrate).

The use of other promotor compounds than mentioned specifically above, is possible as well. The promotor compounds can be chosen from many compounds.

Although not specifically indicated, it is possible to use promotor compounds that can be used to store hydrogen in larger clathrate structures. For example, sH hydrate has a hexagonal structure that may be able to store hydrogen in an amount of about 54 kilogram per m³. The kinetics for forming and dissociating the hydrogen clathrates is not further described herein.

The invention is only restricted by the appended claims. The description as given above is only intended to show one possible embodiment.

What is claimed is:

1. A composition for producing a clathrate hydrate, comprising water and hydrogen, wherein the composition further comprises a promotor compound.

2. A composition according to claim 1, wherein the promotor compound is an organic compound.

3. A composition according to claim 2, wherein the promotor compound is a substituted organic compound.

4. A composition according to claim 2, wherein the promotor compound is a cyclic organic compound.

5. A composition according to claim 4, wherein the promotor compound is a cyclic organic compound with an atom other than carbon, which is pendant or incorporated in the ring.

6. A composition according to claim 5, wherein the promotor compound is a cyclic organic compound with an atom other than carbon, which is pendant or incorporated in the ring, and an oxygen atom, chosen from the group consisting of at least cyclobutanone, tetrahydrofurane, tetrahydropyrane and derivatives thereof.

7. A composition according to claim 1, wherein the promotor compound is an organic compound which is at least partially halogenated.

8. A composition according to claim 1, wherein the composition has a temperature ranging from 150 to 373 degrees K and a pressure ranging from 0.1 to 150 MPa.

9. A method for making a clathrate hydrate, comprising the steps of:
providing a composition according to claim 1;
bringing the composition to a temperature ranging from 150 to 373 degrees K and a pressure ranging from 0.10 to 150 MPa; and
thereby transforming the composition into a crystalline structure.

10. Use of a promotor compound for making a clathrate hydrate with the method according to claim 9.

11. Clathrate hydrate, obtained from a composition according to claim 1.

12. A composition according to claim 6, wherein the promotor compound is chosen from the group consisting of tetrahydrofuranols and tetrahydrofurfuryl alcohols.

13. A composition according to claim 7, wherein the promotor compound is trifluormethane.
